(19) United States
(12) Patent Application Publication
(10) Pub. No.: US 2024/0294786 A1
(43) Pub. Date: Sep. 5, 2024

(54) Printing Inks & Coating Compositions for Polyethylene Coated Board

(71) Applicant: Sun Chemical Corporation, Parsippany, NJ (US)

(72) Inventors: Alexander Lahr, Charlotte, NC (US); Bruce Marshall, Charlotte, NC (US)

(73) Assignee: Sun Chemical Corporation, Parsippany, NJ (US)

(21) Appl. No.: 18/439,053

(22) Filed: Feb. 12, 2024

Related U.S. Application Data
(60) Provisional application No. 63/449,360, filed on Mar. 2, 2023.

(51) Int. Cl. C09D 11/106; B41M 1/04; B41M 1/30; C09D 11/037

(52) U.S. Cl. CPC C09D 11/106; B41M 1/30; C09D 11/037; B41M 1/04

(57) ABSTRACT

The present invention provides a printing ink or coating composition comprising a self-crosslinking acrylic polymer and a silicone emulsion wherein the self-crosslinking acrylic polymer has a minimum film forming temperature of less than 25° C. Furthermore, the present invention also provides a process for preparing a coated substrate, in particular a polyboard substrate, and an article made from the coated substrate, such as a milk or juice carton.

### FIELD OF THE INVENTION

The present invention is directed to water-based inks and coating compositions for printing onto polyboard substrates which are primarily used for milk and juice cartons that provide improved resistance and resolubility performance.

### BACKGROUND OF THE INVENTION

Inks designed to be printed on various substrates, for example polyboard, require high resistance properties to products such as milk, orange juice, and chain lube due to potential spillage of the liquid contents of the container printed on or the lubricants used for the printing press. Previously, these high resistance properties were achieved at the expense of poor resolubility, dirty printing, and difficulty in maintaining inks on press after completing a job. The newly developed technology described in the present application provides improved resolubility, good resistance properties, and easier ink handling on press. Ink handling can be classified as ink resolubility and/or ink clean-up properties. Substandard ink handling properties of the current technology can lead to increased press downtime. The inventive application will allow for significant improvement in ink handling without sacrificing end-use performance.

WO 2000073392 discloses the use of hybrid alkyd acrylic resins in inks for use on polythene coated board used for milk cartons. The inventive technology is of a different chemical composition with a related printing application on polycoated board.

U.S. Pat. No. 7,807,739 discloses an aqueous composition for coating substrates comprising a cross linkable polymer, an acrylic polymer and an epoxysilane. '739 utilizes a metal-containing crosslinkable polymer, acrylic polymer, and an epoxysilane to generate a crosslinking action. The inventive technology requires a single self-crosslinking acrylic polymer to achieve crossslinking.

US2013/0309516 is directed to a coating composition having an acrylic polymer with a low glass transition temperature that contains a crosslinkable functional group and a cross linking agent. Unlike '516, the technology of the present application does not require the use of a crosslinking agent to achieve necessary resistance properties.

JP3301267 is directed to watercolor inks containing a resin for use on corrugated fiberboard. The inventive technology contains watercolor dispersions comprised of acrylic polymer resin. '267 references an application on corrugated fiberboard whereas the inventive technology is utilized on polycoated board.

Finally, CN101812255 is directed to an ink containing an acrylic resin for use on a high temperature resistance carton. The inventive technology is comprised of acrylic resin with an application on polycoated board carton. However, temperature resistance is not a requirement.

### SUMMARY OF THE INVENTION

The present invention provides a water-based printing ink or coating composition comprising:
a) one or more self-crosslinking acrylic polymers,
b) at least one silicone emulsion
   wherein the one or more self-crosslinking acrylic polymers have a minimum film forming temperature (MFFT) of less than 25° C.

Though it is advantageous that all of the self-crosslinking acrylic polymers have an MFFT of less than 25° C., it would also be possible to include self-crosslinking acrylic polymers have an MFFT of greater than 25° C., so long as at least 80%, or more preferably at least 90% of the total amount of self-crosslinking acrylic polymers is based on those with an MFFT less than 25° C.

Furthermore, the present invention also provides a process for preparing a coated substrate, in particular a polyboard substrate, with the ink or a composition printed thereon which comprises:
a) applying the printing ink or coating composition according to the invention to a surface of the substrate and
b) drying the ink or composition.

These and other objects, advantages, and features of the invention will become apparent to those persons skilled in the art upon reading the details of the methods and formulations as more fully described below.

### DETAILED DESCRIPTION OF THE INVENTION

The minimum film forming temperature (MFFT) herein refers to the acrylic polymer prior to self-crosslinking. The minimum film forming temperature (MFFT) is the lowest temperature at which a polymer will coalesce (form a continuous film) when applied to a substrate as a thin film, such as during printing. MFFT is determined using ASTM D2354. The inventive technology will allow for ink films with improved performance properties, especially resolubility. Resolubility is the capability of a dried ink to redissolve by returning to a wet state after being partially dried.

Inventors found that selecting self-crosslinking acrylics with an MFFT below 25° C., provides the following advantages related to improved resolubility:
(a) allows the ink on the printing plate to “rewet” or redissolve to help prevent ink build-up on press and the unfavorable associated consequences, such as poor printability and prints with a “dirty” appearance, especially during press stoppages, where ink is prone to drying on the press;
(b) prevents or minimizes insoluble, hardened ink particles forming on press or in ink containers due to partial drying, especially when exposed to air after the container is opened, which causes print defects and clogging of in-line press filtration equipment;
(c) provides for easier cleanup due to the ink more easily resolubilizing enabling easier removal from the press and associated ink processing equipment.

It has now been found that a printing ink or coating composition containing a self-crosslinking acrylic polymer and at least one silicone emulsion can exhibit good adhesion and requisite resistance properties when the self-crosslinking acrylic polymer has a minimum film forming temperature of less than 25° C.

The printing inks and coating compositions of the present invention are water-based, which provides for improved pigment wetting. This enables the printing inks and coating compositions to contain less colorant thus allowing for higher amounts of varnish. This in turn provides for maximum resistance whilst retaining color strength.

The self-crosslinking acrylic polymer is usually in the form of an aqueous dispersion or emulsion and is typically the product of at least two monomers that react with one another.

Furthermore, a self-crosslinking acrylic polymer refers to a one pack acrylic that, whilst under ambient cure, can achieve curing, typically via a carbonyl/amine reaction. This can occur between ketone groups and bi- or polyfunctional amine compounds having groups that are reactive towards carbonyl groups. These acrylic polymers exhibit enhanced resistance properties in the resultant dried film.

Depending upon the acrylic type, the cross-linking reaction, may also be initiated by the evaporation of water upon drying, a change of pH of the vehicle, or by curing at elevated temperatures where the cross-linking reaction occurs faster or the reactive groups are de-blocked.

Self-crosslinking acrylic polymers may include binders selected from the group consisting of styrene-acrylic ester copolymer, a styrene/acrylic ester copolymer containing acrylamide groups, and advantageously a copolymer based on acrylonitrile, methacrylamide, and acrylic ester.

In one embodiment, the self-crosslinking acrylic polymer is formed from reactive monomers which include at least one monomer selected from methyl acrylic acid (MAA), methyl methacrylate (MMA), butyl acrylate, butyl methacrylate, styrene, and methyl styrene. Advantageously, the self-crosslinking polymer is a styrene/acrylic ester copolymer.

In another embodiment, the polymer is produced via a carbonyl/amine reaction, and advantageously an acrylate with a pendent N-methylol group (such as NIBMA) is used.

In one embodiment the printing ink or coating composition comprises between 20 to 60 wt % of self-crosslinking acrylic polymer, or 40 to 60 wt % of self-crosslinking acrylic polymer.

The printing ink or coating composition also comprises a silicone emulsion.

The addition of a silicone emulsion in the formulation helps to improve various resistance properties, especially chilled wet rub resistance. Preferred silicones are high molecular weight polydimethylsiloxane emulsions, containing reactive silanol groups. Alternatively, a blocked reactive silicone emulsion may be used.

In one embodiment, the printing ink or coating composition comprises between 0.2 to 3 wt % of silicone emulsion, or between 0.5 to 2 wt % of silicone emulsion.

The printing ink or coating composition may optionally further comprise a colorant. Such colorants typically include organic and inorganic pigment dispersions and dyes.

Suitable colorants include but are not limited to: organic or inorganic pigments and dyes. The dyes include but are not limited to fluorescent dyes, azo dyes, anthraquinone dyes, xanthene dyes, azine dyes, combinations thereof and the like. Organic pigments may be one pigment or a combination of pigments, such as for instance Pigment Yellow Numbers 12, 13, 14, 17, 74, 83, 114, 126, 127, 174, 188; Pigment Red Numbers 2, 22, 23, 48:1, 48:2, 52, 52:1, 53, 57:1, 112, 122, 166, 170, 184, 202, 266, 269; Pigment Orange Numbers 5, 16, 34, 36; Pigment Blue Numbers 15, 15:3, 15:4; Pigment Violet Numbers 3, 23, 27; and/or Pigment Green Number 7. Inorganic pigments may be one of the following non-limiting pigments: iron oxides, titanium dioxides, chromium oxides, ferric ammonium ferrocyanides, ferric oxide blacks, Pigment Black Number 7 and/or Pigment White Numbers 6 and 7. Other organic and inorganic pigments and dyes can also be employed, as well as combinations that achieve the colors desired.

In one embodiment, the printing ink or coating composition would be prepared by combining a standard acrylic base containing a pigment dispersion in the amount of between 1 to 35 wt %, a varnish containing the self-crosslinking acrylic polymer, and a silicone emulsion in the amount of between 65 to 99 wt %.

In one embodiment, the printing ink or coating composition comprises between 1 to 50 wt % of pigment dispersion, for example 5-45 wt %, or 15-50 wt % or 30-40 wt % pigment dispersion.

As with most ink and coating compositions, additives may be incorporated to enhance various properties. A partial list of such additives includes but is not limited to adhesion promoters, silicones, light stabilizers, optical brighteners, de-gassing additives, ammonia, flow promoters, defoamers, antifoams, antioxidants, stabilizers, surfactants, dispersants, plasticizers, rheological additives, waxes, silicones, etc.

Examples of such additives include isopropanol and n-propanol; polyethylene wax emulsions such as Joncryl Wax 26 and Byk Aquacer 531; wax dispersions such as Munzing Luba-print SC 5700, Joncryl Wax 4 and Crayvallac WW1001; antifoams such as Byk 023 and Evonik Tegofoamex 1488; and wetting aids such as Evonik TegoWet 500 and Byk Dynwet 800 N.

The printing inks or coating compositions according to the present invention may be used for any kind of printing, but they are advantageously gravure or flexographic printing inks or coating compositions.

In one embodiment, the inks of the present invention would be suitable for use on polyethylene coated board substrates (e.g . . . polyboard); for example, those used to prepare containers (e.g., milk and juice containers). Other substrates may include corrugated paper, paper pre-corrugation, paper, and general board.

In a particular embodiment of the invention the printing inks and coating compositions are formulated such that they can successfully adhere to a polyethylene layer, and, thus, can be printed directly on “pre-formed” polyboard, as opposed to being printed initially on the board. This eliminates the need for extruding polyethylene over the top of a coated board after printing.

In a further embodiment, the printing inks and coating compositions of the present invention would adhere to indirect food contact status regulations and all the materials used therein are compliant with the Toxic Substances Control Act (TOSCA) and would be Food and Drug Administration (FDA) approved.

The present invention also provides a process for preparing a coated substrate with an ink or a composition printed thereon which comprises.
a) applying the printing ink or coating composition as herein described above to a surface of the substrate and
b) drying the ink or composition.

The invention is further described by the examples given below.

### EXAMPLES

### Example 1. Formulation of Inks Containing Various Self-Crosslinking Acrylic Polymers

Typical ranges for the raw materials contained within the formulations of the present invention are as follows:
Self-crosslinking acrylic polymer: 20-60 wt %
SMA varnish: 5-15 wt %. SMA is a highly resoluble copolymer with exceptional rewetting and ink transfer properties (Table 1).

TABLE 1
SMA varnish composition

| | |
|---|---|
| Water | 60.0 |
| Tall oil siloxane/silica defoamer | 0.3 |
| Styrene maleic anhydride | 22.3 |
| Ammonia | 8.4 |
| Water | 9.0 |
| TOTAL | 100 |

Additives e.g., defoamers; waxes; wetting agents: 1-30 wt %
Pigment dispersion: 5-50 wt %. Pigment dispersions are dry color pigments that are dispersed into a medium containing resins, surfactants, and other additives (Table 2)

TABLE 2
Blue 15:3 pigment dispersion composition

| | |
|---|---|
| Acrylic solution | 17.40 |
| Propylene glycol | 2.00 |
| Alcohol ethoxylate wetting agent | 1.10 |
| antimicrobial | 0.40 |
| Water | 34.00 |
| Silicone defoamer | 0.50 |
| Pigment blue 15:3 | 43.50 |
| Ethylene oxide/propylene oxide dispersant | 1.10 |
| TOTAL | 100 |

Ink formulations containing the materials as shown in Table 1 and 2 were formulated using self-crosslinking acrylic polymers having varying minimum film forming temperatures.

TABLE 3
Inventive and Comparative Ink Examples.

| | Ink Ex. 1 | Ink Ex. 2 | Ink Ex. 3 | Ink Ex. 4 |
|---|---|---|---|---|
| Material | (Inventive) | (Comparative) | (Inventive) | (Inventive) |
| Acrylic emulsion (MFFT = 21° C.) | 42.0 | — | — | |
| Acrylic emulsion (MFFT = 33° C.) | — | 42.0 | — | |
| Acrylic emulsion (MFFT < 5° C.) | — | — | 42.0 | |
| Acrylic emulsion (MFFT = 20° C.) | | | | 42 |
| SMA varnish | 9.7 | 9.7 | 9.7 | 9.7 |
| Silicone defoamer | 0.33 | 0.33 | 0.33 | 0.33 |
| Polyethylene wax emulsion | 8.45 | 8.45 | 8.45 | 8.45 |
| Alcohol alkoxylate wetting agent | 1.3 | 1.3 | 1.3 | 1.3 |
| High molecular weight silicone | 0.5 | 0.5 | 0.5 | 0.5 |
| dispersion | | | | |
| Monoethanolamine | 0.12 | 0.12 | 0.12 | 0.12 |
| Isopropanol | 2.6 | 2.6 | 2.6 | 2.6 |
| Blue 15:3 pigment dispersion | 35.0 | 35.0 | 35.0 | 35.0 |
| TOTAL | 100.00 | 100.00 | 100.00 | 100.00 |

The ink examples in Table 3, having a print viscosity of 25 seconds (EZ 2 Zahn cup) were printed using a Harper flexographic bladed hand proofer onto treated polyethylene board and then tested for various properties as shown in the tables below.

Table 4 shows the Sutherland rub resistance results, after 3 days aging for the inks in Table 1.

TABLE 4
Rub Resistance

| | Rub Testing - Milk | | Rub Testing - Orange Juice | | Rub Testing - Condensation | |
|---|---|---|---|---|---|---|
| | Print | Blotter Towel | Print | Blotter Towel | Print | Blotter Towel |
| Sample Tested | Grade | Grade | Grade | Grade | Grade | Grade |
| Ink 1 (Inv.) | 3 | 3 | 4 | 5 | 5 | 5 |
| Ink 2 (Comp.) | 3 | 2 | 4 | 3 | 5 | 5 |
| Ink 3 (Inv.) | 3 | 3 | 4 | 4 | 5 | 5 |
| Ink 4 (Inv.) | 3 | 3 | 4 | 5 | 5 | 5 |

Ratings are 1-5, with 5 being best, based on visual assessment as follows:
1=>40% ink removal
2=30-40% ink removal
3=20-29% ink removal
4=10-19% ink removal
5=≤10% ink removal

The results in Table 4 show that the inventive inks having MFFT<25° C. exhibit superior rub resistance properties compared to comparative ink having an MFFT of >25° C.

Table 5 shows that inks based on self-crosslinking acrylic polymers with a minimum film forming temperature greater than 25° C. exhibit good properties, especially resolubility, which is inferior for the comparative example.

TABLE 5
Other properties (Adhesion, Scratch, Chain Lube, and Resolubility)

| | Ink Ex. 1 | Ink Ex. 2 | Ink Ex. 3 | Ink Ex. 4 |
|---|---|---|---|---|
| Test | (Inv.) | (Comp.) | (Inv.) | (Inv.) |
| Adhesion Tape Testing | 5 | 5 | 5 | 5 |
| Scratch Testing | 5 | 5 | 5 | 5 |
| Chain Lube Testing | 5 | 5 | 5 | 5 |
| Resolubility Testing | 5 | 2 | 4 | 3 |

### Test Methods:

### Adhesion Tape Testing:

Scotch Brand #610 tape was applied over the printed sample to be tested. The tape was smoothed out with the tip of the finger. By hand, the tape was pulled halfway back, slowly, and then quickly for the rest of its length. The test area was then examined for ink removal. To achieve an acceptable passing result, minimal ink removal is required; hence, a score of 5 is considered a pass.

Ratings are 1-5, with 5 being best, based on visual assessment as follows:
1=full ink removal
2=75-99% ink removal
3=50-74% ink removal
4=2-49% ink removal
5=≤2% ink removal

### Scratch Testing:

Each printed sample was placed ink side up on a smooth, hard surface. Printed samples were then scratched several times using the back of an index finger/fingernail. To achieve an acceptable passing result, minimal ink removal is required; hence, a score of 5 is considered a pass.

Ratings are 1-5, with 5 being best, based on visual assessment as follows:
1=full ink removal
2=75-99% ink removal
3=50-74% ink removal
4=2-49% ink removal
5=≤2% ink removal

### Chain Lube Resistance Testing:

3 Drops of diluted Saniglide (20% solution) were applied to the printed samples. Drops were allowed to sit for 30 minutes before removal. After the given time, the drops were removed using blotter towel by applying medium pressure and completing ten strokes (5 cycles) to test for ink removal. To achieve an acceptable passing result, minimal removal is required; hence, a score of 5 is considered a pass.

Ratings are 1-5, with 5 being best, based on visual assessment as follows:
1=full ink removal
2=75-99% ink removal
3=50-74% ink removal
4=2-49% ink removal
5=≤2% ink removal

### Resolubility Testing:

5 drops of ink were applied to hand proofer and allowed to sit and dry for 3 minutes. After 3 minutes, an additional 3 drops were applied while rolling the rubber roller and anilox in an effort to rewet the dry ink. After 1 minute of rolling/rewetting, the anilox is rinsed with water and observed for anilox cell staining. Following the rinse, the anilox is scrubbed with a brush using only water. A final staining inspection of the anilox is performed and recorded. A passing result would be a 3-5 rating (i.e. 50% or less anilox cell staining), though in a preferred embodiment, the rating would be 4 (2-49% less anilox cell staining), or most preferably a 5 rating (less than 2% anilox cell staining).

Ratings are 1-5, with 5 being best, based on visual assessment as follows:
1=complete staining
2=51-99% staining
3=26-50% staining
4=2-25% staining
5=≤2% staining

### Product Rub Resistance Testing:

Printed samples were cut to 2″×7″ and 3″×7″. Cut printed samples were wrapped around 8 oz. glass jars filled with water and placed in a 39° F. refrigerator for 16 hours. The jars were then removed and allowed to sit at room temperature for 30 minutes to form condensation. 6 drops of either milk or orange juice were placed on rub tester bed sample before 4 lb. weight was placed on top. Using a Sutherland 2000 rub tester, rub testing was performed for 30 minutes. When completed, a 2″×2″ folded Kimwipe was used to wipe off excess liquid. The printed surface and Kimwipe are examined for ink removal and staining. To achieve an acceptable passing result, less than 30% surface ink removal is required; hence, a score of 3 or above is considered a pass.

Ratings are 1-5, with 5 being best, based on visual assessment as follows:
1=≥50% ink removal
2=30-49% ink removal
3=20-29% ink removal
4=10-19% ink removal
5=≤10% ink removal

### Condensation Rub Resistance Testing:

Printed samples were cut to 2″×7″ and 3″×7″. Cut printed samples were wrapped around 8 oz. glass jars filled with water and placed in a 39° F. refrigerator for 16 hours. Wrapped jars were then removed and allowed to sit at room temperature for 30 minutes to form condensation. Printed samples were rewet with 6 drops of distilled water and tested using a Sutherland 2000 rub tester for 30 minutes. When completed, a 2″×2″ folded Kimwipe was used to wipe off excess liquid. The printed surface and Kimwipe were examined for ink removal and staining. To achieve an acceptable passing result, less than 30% printed surface ink removal is required; hence, a score of 3 or above is considered a pass.

Ratings are 1-5, with 5 being best, based on visual assessment as follows:
1=≥50% ink removal
2=30-49% ink removal
3=20-29% ink removal
4=10-19% ink removal
5=≤10% ink removal

While the present invention has been described with reference to the specific embodiments thereof, it should be understood by those skilled in the art that various changes may be made, and equivalents may be substituted, without departing from the true spirit and scope of the invention. In addition, many modifications may be made to adapt a particular situation, material, composition of matter, process, process step or steps, to the objective, spirit and scope of the present invention. All such modifications are intended to be within the scope of the invention.

What is claimed is:

1. A printing ink or coating composition comprising:
a) one or more self-crosslinking acrylic polymers having an MFFT of less than 25° C.;
b) one or more silicone emulsions; and
c) water.

2. The composition of claim 1, further comprising one or more self-crosslinking acrylic polymers having an MFFT of greater than 25° C. in an amount less than 20% of the total polymer content.

3. The composition of claim 2, wherein the one or more self-crosslinking acrylic polymers has an MFFT of less than 22° C.

4. The composition of claim 3, further comprising one or more colorants.

5. The composition of claim 4, wherein the one or more self-crosslinking acrylic polymers are formed from monomers selected from methyl acrylic acid (MAA), methyl methacrylate (MMA), butyl acrylate, butyl methacrylate, styrene and methyl styrene.

6. The composition of claim 5, wherein the one or more self-crosslinking polymers are styrene/acrylic ester copolymers.

7. The composition of claim 6, wherein the one or more self-crosslinking polymers are formed from a carbonyl/amine reaction.

8. The composition of claim 7, wherein the silicone emulsion is high molecular weight polydimethylsiloxane emulsion containing reactive silanol groups.

9. The composition of claim 8, comprising between 20 to 60 wt % of self-crosslinking acrylic polymer.

10. The composition of claim 9, comprising between 0.2 to 3 wt % of silicone emulsion.

11. The printing ink or coating composition of claim 10, wherein the colorant is in the form of a pigment dispersion.

12. The composition of claim 11, comprising between 5 to 50 wt % of pigment dispersion.

13. The composition of claim 12, further comprising one or more additives selected from the group consisting of wetting aids, alcohols, polyethylene wax emulsions, wax dispersions, antifoams, waxes, ammonia, defoamers, dispersants, stabilizers, silicones, rheological modifiers, and plasticizers.

14. The composition of claim 13, wherein the composition is a gravure or flexographic printing ink or coating composition.

15. The composition of claim 14, which is substantially free of epoxyesters.

16. A process for preparing a coated substrate with an ink or a coating composition printed thereon which comprises:
a) applying the printing ink or coating composition of claim 1 to the surface of a substrate; and
b) drying the ink or coating composition.

17. The process of claim 16, wherein the substrate is polyethylene board.

18. A coated substrate prepared by the process of claim 16.

19. A printed article formed from the coated substrate of claim 18.

20. The article of claim 19, wherein the article is a food or beverage carton.
